(19) United States
(12) Patent Application Publication
(10) Pub. No.: US 2022/0285671 A1
(43) Pub. Date: Sep. 8, 2022

(54) LITHIUM SULFATE COATED ANODE ACTIVE MATERIAL

(71) Applicant: STOREDOT LTD., Herzeliya (IL)

(72) Inventor: Shirel COHEN, Tel-Aviv (IL)

(73) Assignee: STOREDOT LTD., Herzeliya (IL)

(21) Appl. No.: 17/652,949

(22) Filed: Mar. 1, 2022

Related U.S. Application Data
(60) Provisional application No. 63/156,293, filed on Mar. 3, 2021.

(51) Int. Cl. H01M 4/36; H01M 10/0525; H01M 4/587; H01M 4/485

(52) U.S. Cl. CPC H01M 4/366; H01M 10/0525; H01M 4/364; H01M 4/587; H01M 4/485; H01M 2004/027

(57) ABSTRACT

A manufacturing method related to a slurry, the method may include preparing a slurry that comprises anode active material, one or more binders and one or more additives, wherein the anode active material are partially coated anode active material that are partially coated with lithium sulfate

### CROSS REFERENCE

This application claims priority from U.S. provisional patent 63/156,293 filing date Mar. 3, 2021 which is incorporated herein by reference.

### BACKGROUND

During the first cycle of lithium-ion batteries, solvent decomposition reaction at the surface of the electrode will result in formation of a passivating surface film, which is commonly named as the solid electrolyte interface (SEI). More importantly, the properties of SEI film directly determine the whole performance of the battery.

A small amount of film forming additive added into the electrolyte may improve the performance of the battery because of occurrence of reductive decomposition preferentially, which form SEI at the surface of the graphite electrode. In order to find good electrolyte matching with graphite, it is necessary to search for functional additives which can form effective SEI film. Ethylene sulfate (DTD) is known as effective film-forming additive. DTD is a film formation electrolyte additive, which get reduced prior to the carbonates components and by that, a sulfur rich SEI is obtained.

FIG. 1 includes images of anodes after cycling. The left image 11 is of an anode formed when DTD is not included in the electrolyte. The right image 12 is of an anode formed when DTD was included in the electrolyte. Metallization of the anode of the left image 11 can clearly be seen.

### SUMMARY

There may be provided a manufacturing method related to a slurry, the method may include preparing a slurry that may include anode active material, one or more binders and one or more additives, wherein the anode active material may be partially coated anode active material that may be partially coated with lithium sulfate.

The preparing of the slurry may include mixing the anode active material, the lithium sulfate, the one or more binders, and the one or more additives.

The preparing of the slurry may include mixing the anode active material with the lithium sulfate to provide the partially coated anode active material; and mixing the partially coated anode active material with the one or more binders, and the one or more additives.

The anode active material may be graphite.

The anode active material may be carbon that differ from graphite.

The anode active material may be metalloid compound.

The anode active material may be lithium titanate oxide.

The anode active material may be a mixture of at least two of (a) graphite, (b) carbon that differ from graphite, (c) metalloid compound, or (d) lithium titanate oxide.

The manufacturing method may include determining a percentage of lithium sulfate in relation to the anode active material based on a consumption of Ethylene sulfate by an anode of a lithium ion cell from an electrolyte of the lithium ion battery.

The percentage of lithium sulfate in relation to the anode active material may be determined based on a consumption of Ethylene sulfate by an anode of a lithium ion cell from an electrolyte of the lithium ion battery.

The manufacturing method may include providing electrolyte that lacks Ethylene sulfate.

There may be provided a slurry that may include anode active material, one or more binders and one or more additives, wherein the anode active material may be partially coated anode active material that may be partially coated with lithium sulfate.

The slurry may be manufactured by a manufacturing process that may include mixing the anode active material, the lithium sulfate, the one or more binders, and the one or more additives.

The slurry may be manufactured by a manufacturing process that may include mixing the anode active material with the lithium sulfate to provide the partially coated anode active material; and mixing the partially coated anode active material with the one or more binders, and the one or more additives.

The anode active material may be graphite.

The anode active material may be carbon that differ from graphite.

The anode active material may be metalloid compound.

The anode active material may be lithium titanate oxide.

The anode active material may be a mixture of at least two of (a) graphite, (b) carbon that differ from graphite, (c) metalloid compound, or (d) lithium titanate oxide.

The slurry may be manufactured by a manufacturing process that may include determining a percentage of lithium sulfate in relation to the anode active material based on a consumption of Ethylene sulfate by an anode of a lithium ion cell from an electrolyte of the lithium ion battery.

The percentage of lithium sulfate in relation to the anode active material may be determined based on a consumption of Ethylene sulfate by an anode of a lithium ion cell from an electrolyte of the lithium ion battery.

There may be an anode of a lithium ion cell, wherein the anode may be manufactured by a manufacturing method that may include preparing a slurry that may include anode active material, one or more binders and one or more additives, wherein the anode active material may be partially coated anode active material that may be partially coated with lithium sulfate.

The preparing of the slurry may include mixing the anode active material, the lithium sulfate, the one or more binders, and the one or more additives.

The preparing of the slurry may include mixing the anode active material with the lithium sulfate to provide the partially coated anode active material; and mixing the partially coated anode active material with the one or more binders, and the one or more additives.

The anode active material may be graphite.

The anode active material may be carbon that differ from graphite.

The anode active material may be metalloid compound.

The anode active material may be lithium titanate oxide.

The anode active material may be a mixture of at least two of (a) graphite, (b) carbon that differ from graphite, (c) metalloid compound, or (d) lithium titanate oxide.

The manufacturing method may include determining a percentage of lithium sulfate in relation to the anode active material based on a consumption of Ethylene sulfate by an anode of a lithium ion cell from an electrolyte of the lithium ion battery.

The percentage of lithium sulfate in relation to the anode active material may be determined based on a consumption of Ethylene sulfate by an anode of a lithium ion cell from an electrolyte of the lithium ion battery.

The manufacturing method further may include providing electrolyte that lacks Ethylene sulfate.

There may be a rechargeable lithium ion cell that may be manufactured by a manufacturing method that may include preparing a slurry that may include anode active material, one or more binders and one or more additives, wherein the anode active material may be partially coated anode active material that may be partially coated with lithium sulfate.

The preparing of the slurry may include mixing the anode active material, the lithium sulfate, the one or more binders, and the one or more additives.

The preparing of the slurry may include mixing the anode active material with the lithium sulfate to provide the partially coated anode active material ; and mixing the partially coated anode active material with the one or more binders, and the one or more additives.

The anode active material may be graphite.

The anode active material may be carbon that differ from graphite.

The anode active material may be metalloid compound.

The anode active material may be lithium titanate oxide.

The anode active material may be a mixture of at least two of (a) graphite, (b) carbon that differ from graphite, (c) metalloid compound, or (d) lithium titanate oxide.

The manufacturing method may include determining a percentage of lithium sulfate in relation to the anode active material based on a consumption of Ethylene sulfate by an anode of a lithium ion cell from an electrolyte of the lithium ion battery.

The percentage of lithium sulfate in relation to the anode active material may be determined based on a consumption of Ethylene sulfate by an anode of a lithium ion cell from an electrolyte of the lithium ion battery.

The manufacturing method further may include providing electrolyte that lacks Ethylene sulfate.

There may be provided a method for power supply, wherein the method may include supplying power by a rechargeable lithium ion cell, wherein the rechargeable lithium ion cell may be manufactured by a manufacturing method that may include preparing a slurry that may include anode active material, one or more binders and one or more additives, wherein the anode active material may be partially coated anode active material that may be partially coated with lithium sulfate.

The method may include supplying current (discharging), by the rechargeable lithium ion cell, at a rate that ranges between 5 C and at least 50 C. The supplying of the current can be made in any charging rate — for example — below 1 C, between 1 C and 5 C, above 5 C. The method may include charging the rechargeable lithium ion cell at any charging rate—below 1 C, between 1 C and 5 C, above 5 C, and the like.

The preparing of the slurry may include mixing the anode active material, the lithium sulfate, the one or more binders, and the one or more additives.

The preparing of the slurry may include mixing the anode active material with the lithium sulfate to provide the partially coated anode active material; and mixing the partially coated anode active material with the one or more binders, and the one or more additives.

The anode active material may be graphite.

The anode active material may be carbon that differ from graphite.

The anode active material may be metalloid compound.

The anode active material may be lithium titanate oxide.

The anode active material may be a mixture of at least two of (a) graphite, (b) carbon that differ from graphite, (c) metalloid compound, or (d) lithium titanate oxide.

The manufacturing method may include determining a percentage of lithium sulfate in relation to the anode active material based on a consumption of Ethylene sulfate by an anode of a lithium ion cell from an electrolyte of the lithium ion battery.

The percentage of lithium sulfate in relation to the anode active material may be determined based on a consumption of Ethylene sulfate by an anode of a lithium ion cell from an electrolyte of the lithium ion battery.

The manufacturing method further may include providing electrolyte that lacks Ethylene sulfate.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of prior art anodes;

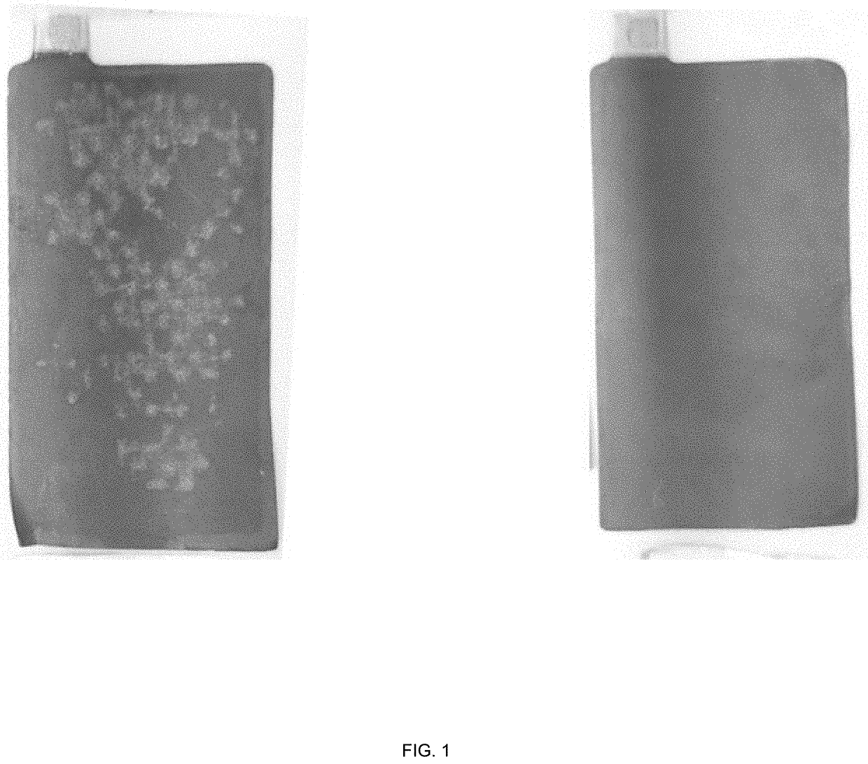

FIG. 2 illustrates an example of a cycle life comparison between different samples;

FIG. 3 illustrates an example of a cycle life comparison between different samples; and

FIG. 4 illustrates an example of a manufacturing method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system or device, unit, mechanism, circuit or apparatus capable of executing the method.

The term “substantially”—unless stated otherwise may refer to a deviation of few percent (for example—deviation of up to 5%, 10%, 15%, or 20%).

Any combination of any system, device, unit, mechanism, circuit, module or component listed in any of the figures, any part of the specification and/or any claims may be provided. Especially any combination of any claimed feature may be provided.

Any material illustrated below (for example anode active material, lithium sulfite) can be in any form—particles, solution, and the like.

There may be provided a method for coating anode active material (such as a raw anode material—such as graphite—or any other anode active material listed below) with lithium sulfate (available & cheap) as an artificial SEI, since lithium sulfate is the final reduction product of DTD during the cell operation.

The coating with the lithium sulfate may make the addition of the DTD to the electrolyte obsolete—and the electrolyte of the cell may be without DTD.

The coating with the lithium sulfate is a controlled process—in contrary to the consumption of the DTD any the node—and is much more effective that providing DTD to the electrolyte and inherently using a non-optimal DTD consumption process in which not all of the DTD is actually consumed by the anode to form an SEI.

The coating process is performed by mixing of anode active material and lithium sulfate, prior to slurry preparation—that may include mixing the lithium sulfite coated active anode material with other materials such as binders to form the slurry.

There may be provided a graphite anode that is manufactured by solid mixing of graphite and lithium sulfate, prior to slurry preparation.

There may be provided a cell that includes one or more graphite anodes that are manufactured by mixing of an anode material and lithium sulfate, prior to slurry preparation.

Examples of the anode active material may be graphite (i.e. amorphous carbon, artificial graphite, natural graphite, and etc), other types of carbons, metalloid compounds (Si, Ge, Sn, etc), lithium titanate oxide (LTO) and any mix thereof.

Some of the example mentioned in the applications refer to an anode material that is graphite. This is for simplicity of explanation.

This mixing is a mechanical mixing process and can be a dry mixing process, a wet mixing process or combination thereof. For example: solid mixing, ball-milling, homogenizer, etc. The mechanical mixing of the anode active material and lithium sulfate accrues prior to slurry preparation (It is a pre-treatment of the active material, which is part of the slurry preparation process.).

There may be provided a method for supplying power from a cell that includes one or more graphite anodes that are manufactured by solid mixing of graphite and lithium sulfate, prior to slurry preparation.

The coating process that include solid mixing of anode material (for example—graphite—or any of the mentioned above anode materials) and lithium sulfate, prior to slurry preparation may provide the following benefits:
a. Cycle life improvement.
b. Rate capability improvement.
c. Reduction of the lithium loss and risk of the metallization.

Significantly higher cycle life was observed for the anode with Li₂SO₄ coated graphite in comparison to standard electrolyte (1M LiPF6 EC:DMC 3:7 2% VC) and DTD as additive (1M LiPF₆ EC:DMC 3:7 2% VC 3%DTD).

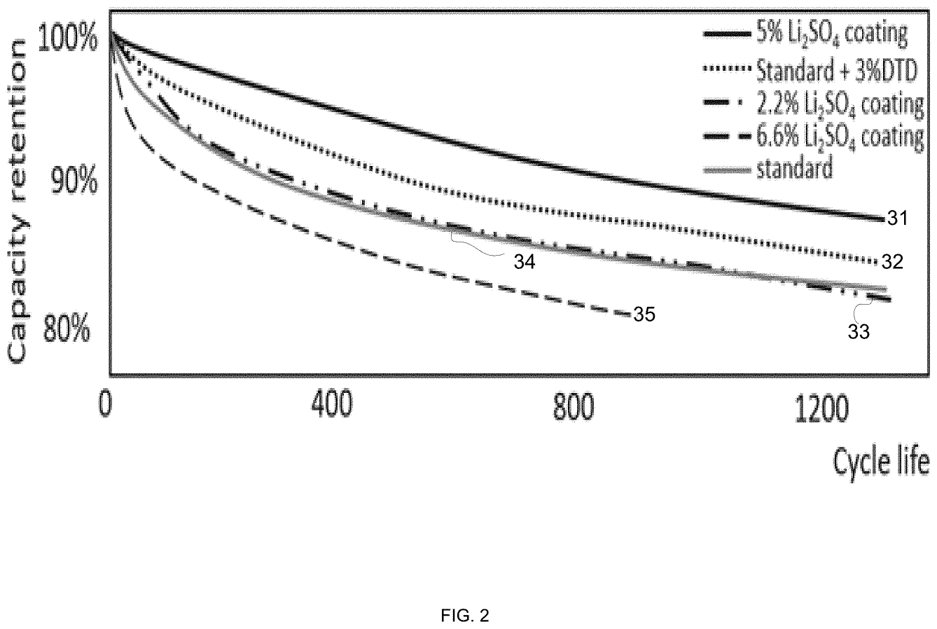

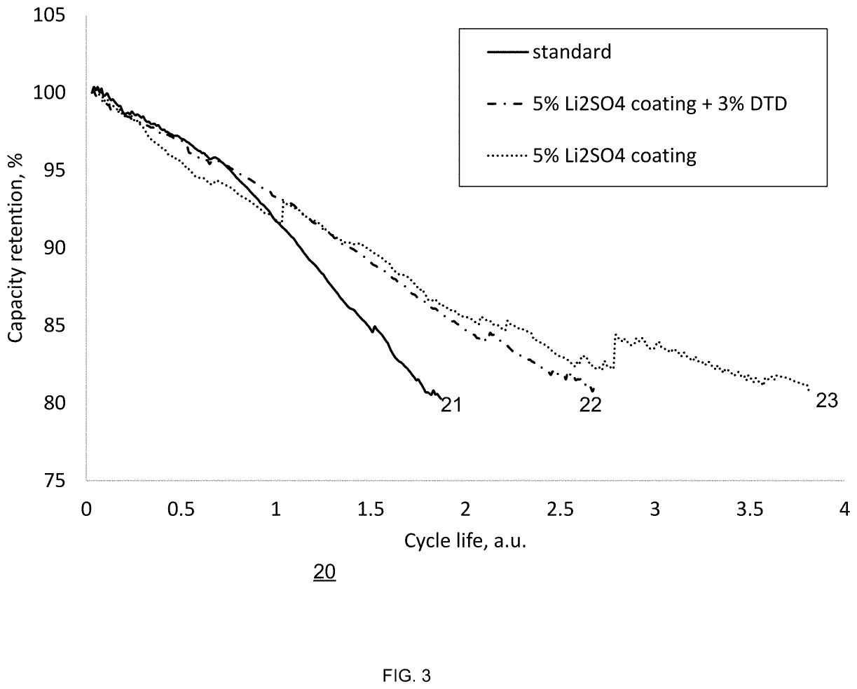

FIGS. 2 and 3 illustrate examples (see curves 21, 22 and 23 of FIG. 2 and curves 31, 32, 33, 34 and 35 of FIG. 3) of lifespan of various cells with different compositions of anodes.

Additionally, different amounts of Li₂SO₄ were investigated (the percentage of the Li₂SO₄ is calculated as a percent of the Li₂SO₄ of the mixture—while the percentage of the DTD is the percentage of the DTD from the electrolyte):
a. _{2.2}% Li₂SO₄ coating (equivalent to 1% DTD consumption from the electrolyte by the anode, commonly reported in the literature);
b. _{6.6}% Li₂SO₄ coating (equivalent to complete 3% DTD consumption from the electrolyte by the anode);
c. ₅% Li₂SO₄ coating (equivalent to the actual DTD consumption, using 3% DTD additive).

A mapping between the percentage of the Li₂SO₄ to the percentage of the DTD may be replaced by a mapping between the amount of the Li₂SO₄ to the amount of DTD.

The percent (volume or weight) of the lithium sulfate may be determined based on the expected and/or measured DTD consumption from the electrolyte by the anode—which should be substantially equal to the DTD amount in the electrolyte. Substantially equal—may allow deviations (from being equal) of up to 5, 10, 15, 20 percent, and the like.

The DTD consumption from the electrolyte by the anode may be determined in at least one manner—such as (i) simulation of the DTD consumption from the electrolyte by the anode, (ii) measurements of the DTD consumption from the electrolyte by the anode, (iii) using a neural network to predict the DTD consumption from the electrolyte by the anode, or any combination of at least two out if (a), (ii) and (iii).

The amount of DTD in the electrolyte may be selected to be substantially equal (and preferably not lower then) to the DTD consumption from the electrolyte by the anode. The amount of the DTD in the electrolyte may be optimized to be equal to the amount of consumed DTD.

The determining (for example optimization) of DTD percentage in the electrolyte may include comparing properties (foe example lifespan) of cells with electrolytes with various amount of DTDs.

The amount of consumed DTD may be measured, for example, by performing electrolyte composition analysis at end of life stage in order to evaluate the amount of DTD that was actually consumed. This measured consumed DTD provides a maximum possible value of DTD consumed by the anode—since not all DTD may have been consumed by the active material of the anode).

The calculation and/or estimation of the consumed DTD may be followed by calculating the required Li₂SO₄ that should be added by the mixing process.

A mapping between values of consumed DTD and required Li₂SO₄ may be determined based in at least one manner—such as (iv) simulation of the mapping, (v) measurements of the mapping (for example performing experiments, (vi) using a neural network to predict the mapping, or any combination of at least two out if (iv), (v) and (vi).

The calculating of the mapping may be based on an assumption that all the consumed DTD was fully reduced—but this is merely an example and this assumption may be ignored of

It should be noted that the addition of the lithium sulfate can be executed regardless of the DTD and regardless of the amount of consumed DTD.

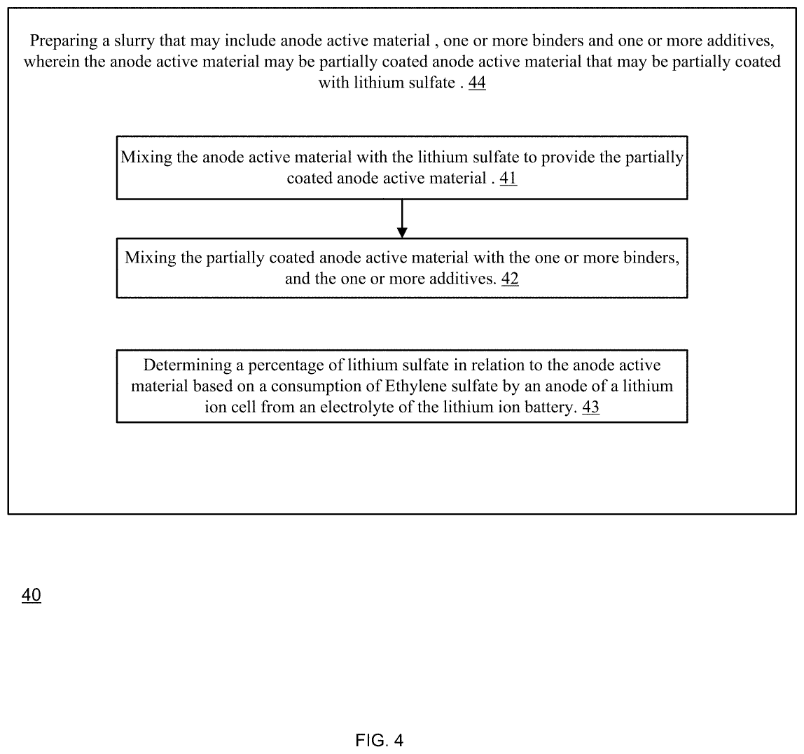

FIG. 4 illustrates manufacturing method 40.

Manufacturing method 40 may be used for providing a slurry, for providing a lithium ion cell or for providing any other intermediate outcome during the manufacturing of a lithium ion cell.

Manufacturing method 40 include step 44 of preparing a slurry that may include anode active material, one or more binders and one or more additives, wherein the anode active material may be partially coated anode active material that may be partially coated with lithium sulfate.

Step 44 may include mixing the anode active material, the lithium sulfate, the one or more binders, and the one or more additives.

Step 44 may include two phases—(i) a first phase (41) of mixing the anode active material with the lithium sulfate to provide the partially coated anode active material, and (ii) a second phase (43) of mixing the partially coated anode active material with the one or more binders, and the one or more additives. The dual phases may prevent (or reduce) the attachment of lithium sulfate to the one or more binders or to the one or more additives—and may be regarded as more effective (in the usage of lithium sulfate) that a single-phase mixing process.

The anode active material may be at least one out of (a) graphite, (b) carbon that differ from graphite, (c) metalloid compound, or (d) lithium titanate oxide.

Method 40 may include step 43 of determining a percentage of lithium sulfate in relation to the anode active material based on a consumption of Ethylene sulfate by an anode of a lithium ion cell from an electrolyte of the lithium ion battery.

Alternatively, method 40 may receive the percentage of lithium sulfate in relation to the anode active material—wherein the percentage may be determined based on a consumption of Ethylene sulfate by an anode of a lithium ion cell from an electrolyte of the lithium ion battery.

When the manufacturing process is not limited just to the provision of slurry—it may include additional steps such as but not limited to anode formation, electrolyte filling, and the like. In this case—method 40 may include providing electrolyte that lacks Ethylene sulfate.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between blocks are merely illustrative and that alternative embodiments may merge blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A manufacturing method related to a slurry, the method comprises:
preparing a slurry that comprises anode active material, one or more binders and one or more additives, wherein the anode active material are partially coated anode active material that are partially coated with lithium sulfate.

2. The manufacturing method according to claim 1, wherein the preparing of the slurry comprises mixing the anode active material, the lithium sulfate, the one or more binders, and the one or more additives.

3. The manufacturing method according to claim 1, wherein the preparing of the slurry comprises: mixing the anode active material with the lithium sulfate to provide the partially coated anode active material; and mixing the partially coated anode active material with the one or more binders, and the one or more additives.

4. The manufacturing method according to claim 1, wherein the anode active material are graphite.

5. The manufacturing method according to claim 1, wherein the anode active material are carbon that differ from graphite.

6. The manufacturing method according to claim 1, wherein the anode active material are metalloid compound.

7. The manufacturing method according to claim 1, wherein the anode active material are lithium titanate oxide.

8. The manufacturing method according to claim 1, wherein the anode active material are a mixture of at least two of (a) graphite, (b) carbon that differ from graphite, (c) metalloid compound, or (d) lithium titanate oxide.

9. The manufacturing method according to claim 1, comprising determining a percentage of lithium sulfate in relation to the anode active material based on a consumption of Ethylene sulfate by an anode of a lithium ion cell from an electrolyte of the lithium ion battery.

10. The manufacturing method according to claim 1, wherein a percentage of lithium sulfate in relation to the anode active material is determined based on a consumption of Ethylene sulfate by an anode of a lithium ion cell from an electrolyte of the lithium ion battery.

11. The manufacturing method according to claim 1, further comprising providing electrolyte that lacks Ethylene sulfate.

12. A slurry that comprises anode active material, one or more binders and one or more additives, wherein the anode active material are partially coated anode active material that are partially coated with lithium sulfate.

13. The slurry according to claim 12, wherein the slurry is manufactured by a manufacturing process that comprises mixing the anode active material, the lithium sulfate, the one or more binders, and the one or more additives.

14. The slurry according to claim 12, wherein the slurry is manufactured by a manufacturing process that comprises:
mixing the anode active material with the lithium sulfate to provide the partially coated anode active material; and
mixing the partially coated anode active material with the one or more binders, and the one or more additives.

15. The slurry according to claim 12, wherein the anode active material are graphite.

16. The slurry according to claim 12, wherein the anode active material are carbon that differ from graphite.

17. The slurry according to claim 12, wherein the anode active material are metalloid compound.

18. The slurry according to claim 12, wherein the anode active material are lithium titanate oxide.

19. The slurry according to claim 12, wherein the anode active material are a mixture of at least two of (a) graphite, (b) carbon that differ from graphite, (c) metalloid compound, or (d) lithium titanate oxide.

20. The slurry according to claim 12, wherein the slurry is manufactured by a manufacturing process that comprises determining a percentage of lithium sulfate in relation to the anode active material based on a consumption of Ethylene sulfate by an anode of a lithium ion cell from an electrolyte of the lithium ion battery.

21. The slurry according to claim 12, wherein a percentage of lithium sulfate in relation to the anode active material is determined based on a consumption of Ethylene sulfate by an anode of a lithium ion cell from an electrolyte of the lithium ion battery.

22. An anode of a lithium ion cell, wherein the anode is manufactured by a manufacturing method that comprises preparing a slurry that comprises anode active material, one or more binders and one or more additives, wherein the anode active material are partially coated anode active material that are partially coated with lithium sulfate.

23. A rechargeable lithium ion cell that is manufactured by a manufacturing method that comprises preparing a slurry that comprises anode active material, one or more binders and one or more additives, wherein the anode active material are partially coated anode active material that are partially coated with lithium sulfate.

24. A method for power supply, wherein the method comprises supplying power by a rechargeable lithium ion cell, wherein the rechargeable lithium ion cell is manufactured by a manufacturing method that comprises preparing a slurry that comprises anode active material, one or more binders and one or more additives, wherein the anode active material are partially coated anode active material that are partially coated with lithium sulfate.
